(19) United States
(12) Patent Application Publication
(10) Pub. No.: US 2005/0180426 A1
(43) Pub. Date: Aug. 18, 2005

(54) Network resource-reserving apparatus and method

(76) Inventors: Yoshifumi Sakata, Kasuga (JP); Yuichi Kawaguchi, Kasuya-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/056,240

(22) Filed: Feb. 14, 2005

(30) Foreign Application Priority Data
Feb. 18, 2004 (JP) 2004-041085

(51) Int. Cl. H04L 12/26; H04L 12/56

(52) U.S. Cl. 370/395.2; 370/468; 709/223; 709/229

(57) ABSTRACT

In an edge router, bands of the input flow are measured to store flow characteristic information of the input flow, thereby permitting network resources required for the input flow to be reserved without requiring users to operate the edge router to set up network resource reservation. This feature provides the guaranteed quality of the flow from a communication terminal that is non-responsive to the network resource reservation.

### BACKGROUND OF THE INVENTION

1. Field of the Invention

The present invention relates to a network resource-reserving apparatus and method for use in a network that supports network resource reservation (hereinafter simply called “reservation”).

2. Description of the Related Art

In IP networks, some QoS (quality of service) arts are operable to guarantee communication service quality based on network resource reservation.

In this connection, a RSVP (Resource Reservation Protocol) is available, which is standardized as a network resource-reserving protocol by IETF (Internet Engineering Task Force), an organization that standardizes Internet technologies. Assume that the RSVP is used to reserve network resources such as transmission bands on a pathway between a transmission server and a receiving client. In this situation, the discard or delay of packets that form stream data to be transmitted is suppressed within a limited range, regardless of the degree of loads imposed on the transmission pathway. This feature provides guaranteed service quality.

A wireless LAN (local area network) according to IEEE (Institute of Electrical and Electronics Engineers) 802.11e may be used as one of the network resource-reserving QoS arts.

The network resource-reserving QoS arts act on the premise that all communication terminals are primarily responsive to the reservation. In this regard, cited reference No. 1 (published Japanese Patent Application Laid-Open No. 2001-292167) discloses an art operable to guarantee the service quality, even with the use of communication terminals non-responsive to the reservation, by allowing the network resources to be reserved by an edge rooter having the communication terminals hierarchically arranged under the edge router.

In general, to reserve the network resources, users must determine reservation parameters based on flow characteristic information, and must feed the determined reservation parameters into a network resource-reserving apparatus. The flow characteristic information is a combination of flow-identifying information such as a source IP address and a destination IP address, and flow characteristic-representing information such as a maximum flow rate and an average rate. The reservation parameters are a combination of flow communication quality-guaranteeing information, such as the source IP address, the destination IP address, a flow reservation rate, and a maximum delay time.

However, it is difficult for the users to recognize the reservation parameters. Even with users who are aware of the reservation parameters, it is difficult to set up the reservation parameters when they have no knowledge about networks. In addition, when the users erroneously set up the flow characteristic information, then the flow service quality cannot be guaranteed.

According to the disclosed art in cited Reference No. 1, when a flow rate is varied, or typically when a certain flow begins to stream, then the quality guarantee of the certain flow is unachievable during a period of time that elapses between the moment when bands of the certain flow to be reserved start to stream and the moment when the reservation for the measured bands is completed after measuring the stream of the certain flow. For example, when a flow of moving image data is streamed, then some of the moving images at the head thereof are degraded in image quality. In addition, the same phenomenon repeatedly occurs when the certain flow or similar flow begins to stream next time or subsequently thereto. Therefore, there has been a need to address the problems.

### OBJECTS AND SUMMARY OF THE INVENTION

In view of the above, an object of the present invention is to provide a network resource-reserving apparatus designed to provide the guaranteed service quality of the flow without requesting users to set up network resource reservation, and to cope with variations in flow rate.

A first aspect of the present invention provides a network resource-reserving apparatus connected to a network that supports network resource reservation, the network resource-reserving apparatus comprising: a control unit operable to identify the input flow with reference to flow-defining information; a reserving unit operable to make a request of the network for the network resource reservation; a measuring unit operable to measure flow characteristic information, in which the flow characteristic information includes the flow-defining information and flow-required network resource information; and a flow characteristic information storage unit operable to store the flow characteristic information previously measured by the measuring unit. When a certain condition is met, the reserving unit makes a request of the network for the network resource reservation in accordance with the flow characteristic information stored by the flow characteristic information storage unit.

The above structure eliminates the need for users to set up reservation parameters. More specifically, when the new flow enters the network resource-reserving apparatus, then previously measured flow characteristic information in the network resource-reserving apparatus can be used to make a network resource reservation without the need to await results from the measurement of the flow characteristic information of the input flow. This feature provides the prompt quality guarantee of the input flow.

A second aspect of the present invention provides a network resource-reserving apparatus as defined in the first aspect of the present invention, in which when the flow characteristic information previously measured by the measuring unit is unavailable, the reserving unit makes a request of the network for the network resource reservation in accordance with the maximum available network resource.

The above structure eliminates the need for users to set up the reservation parameters. More specifically, when previously measured flow characteristic information is unavailable in the network resource-reserving apparatus, and when the new flow enters the network resource-reserving apparatus, maximum network resources ready for reservation can be used to make a reservation without the need to await results from the measurement of the flow characteristic information of the input flow. This feature provides the prompt quality guarantee of the input flow. As a result, assuming that the input flow is a flow of moving images, degradation in image quality is operatively suppressible, which otherwise would often occurs, in particular, at the heads of the moving images.

A third aspect of the present invention provides a network resource-reserving apparatus as defined in the first aspect of the present invention, in which when the flow characteristic information previously measured by the measuring unit is unavailable, the reserving unit makes a request of the network for the network resource reservation in accordance with a network resource having a fixed value.

The above structure allows a network resource reservation to be made in accordance with an expected maximum rate such as, e.g., 24 Mbps for HDTV, and consequently the quality guarantee of any flow is achievable.

A fourth aspect of the present invention provides a network resource-reserving apparatus as defined in the first aspect of the present invention, in which when the flow characteristic information previously measured by the measuring unit is unavailable, the reserving unit makes a request of the network for the network resource reservation in accordance with a maximum network resource specified by a standard that is observed by the input flow.

The above structure eliminates the need for users to set up the reservation parameters. More specifically, when previously measured flow characteristic information is unavailable in the network resource-reserving apparatus, and when the new flow enters the network resource-reserving apparatus, network resources permitted to the maximum extent by the standard can be used to make a reservation without the need to await results from the measurement of the flow characteristic information of the input flow. This feature eliminates network resource reservation based on large resources unimaginable according to the standard, and consequently provides resources that can be allocated to other flows, thereby providing the prompt quality guarantee of the input flow.

A fifth aspect of the present invention provides a network resource-reserving apparatus as defined in the first aspect of the present invention, in which the reserving unit makes a request of the network for re-reservation in accordance with a required network resource shown by the flow characteristic information of the input flow measured by the measuring unit, when the required network resource shown by the flow characteristic information of the input flow measured by the measuring unit is greater than a network resource shown by the flow characteristic information stored in the flow characteristic information storage unit.

The above structure copes with dynamic variations in network resources required by the input flow, and accommodates variations in input flow, thereby providing the quality guarantee of the input flow.

A sixth aspect of the present invention provides a network resource-reserving apparatus as defined in the first aspect of the present invention, in which the reserving unit makes a request of the network for re-reservation in accordance with a greater network resource selected from between a required network resource shown by the flow characteristic information of the input flow measured by the measuring unit and a network resource shown by the flow characteristic information stored in the flow characteristic information storage unit.

The above structure is designed to make such a comparison in size, thereby providing a quality guarantee that meets variations in input flow.

A seventh aspect of the present invention provides a network resource-reserving apparatus as defined in the first aspect of the present invention, in which, with the input flow for which the network resource reservation is requested by the reserving unit, the control unit provides optimized network resources in accordance with network resources shown by the flow characteristic information of the input flow measured by the measuring unit, and in which the reserving unit makes a request of the network for re-reservation in accordance with the optimized network resources.

An eighth aspect of the present invention provides a network resource-reserving apparatus as defined in the seventh aspect of the present invention, in which the control unit provides the optimized network resources in such a manner as to provide minimum required network resources.

Assuming that the input flow is a flow of moving images, the above structures according to the seventh and eight aspects of the present invention operatively suppresses degradation in image quality, which otherwise would often occurs, in particular, at the heads of the moving images. Furthermore, the above structures according to the seventh and eight aspects of the present invention optimizes the network resources after the heads of the moving images are moved through, thereby providing more resources that can be allocated to other flows. This is one of features of the seventh and eight aspects of the present invention, in addition to the prompt quality guarantee of the input flow as the major feature exhibited by all aspects of the present invention.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is an illustration showing a system according to a first embodiment;

FIG. 2 is a block diagram illustrating an edge router according to the first embodiment;

FIG. 3 is an illustration showing a QoS control table according to the first embodiment;

FIG. 4 is an illustration showing a flow characteristic table according to the first embodiment;

FIG. 5 is an illustration showing a measured flow characteristic table according to the first embodiment;

FIG. 6 is an illustration showing priority condition database according to the first embodiment;

FIG. 7 is a block diagram showing the hardware of the edge router according to the first embodiment;

FIG. 8 is a flowchart showing behaviors of the edge router according to the first embodiment;

FIG. 9 is a flowchart illustrating initial reservation processing executed by the edge router according to the first embodiment;

FIG. 10 is a flowchart illustrating subsequent reservation processing executed by the edge router according to the first embodiment;

FIG. 11(a) is an illustration showing a QoS control table according to the first embodiment;

FIG. 11(b) is an illustration showing a QoS control table according to the first embodiment;

FIG. 11(c) is an illustration showing a QoS control table according to the first embodiment;

FIG. 11(d) is an illustration showing a QoS control table according to the first embodiment;

FIG. 11(e) is an illustration showing a QoS control table according to the first embodiment;

FIG. 12(a) is an illustration showing a flow characteristic table according to the first embodiment;

FIG. 12(b) is an illustration showing a flow characteristic table according to the first embodiment;

FIG. 12(c) is an illustration showing a flow characteristic table according to the first embodiment;

FIG. 12(d) is an illustration showing a flow characteristic table according to the first embodiment;

FIG. 13(a) is an illustration showing a measured flow characteristic table according to the first embodiment;

FIG. 13(b) is an illustration showing a measured flow characteristic table according to the first embodiment;

FIG. 13(c) is an illustration showing a measured flow characteristic table according to the first embodiment;

FIG. 13(d) is an illustration showing a measured flow characteristic table according to the first embodiment;

FIG. 13(e) is an illustration showing a measured flow characteristic table according to the first embodiment;

FIG. 13(f) is an illustration showing a measured flow characteristic table according to the first embodiment;

FIG. 14(a) is an illustration showing an input rate and a reservation rate according to the first embodiment;

FIG. 14(b) is an illustration showing an input rate and a reservation rate according to the first embodiment;

FIG. 14(c) is an illustration showing an input rate and a reservation rate according to the first embodiment;

FIG. 14(d) is an illustration showing an input rate and a reservation rate according to the first embodiment;

FIG. 14(e) is an illustration showing an input rate and a reservation rate according to the first embodiment;

FIG. 14(f) is an illustration showing an input rate and a reservation rate according to the first embodiment;

FIG. 15 is an illustration showing a system according to a second embodiment;

FIG. 16 is a block diagram illustrating a wireless relay unit according to the second embodiment;

FIG. 17 is a block diagram illustrating the hardware of the wireless relay unit according to the second embodiment;

FIG. 18 is an illustration showing a standard flow characteristic table according to the second embodiment; and

FIG. 19 is an illustration showing a measured flow characteristic table according to the second embodiment.

### DETAILED DESCRIPTION OF THE PREFERRED EMBODIMENTS

Preferred embodiments of the present invention are now described with reference to the accompanying drawings.

### First Embodiment

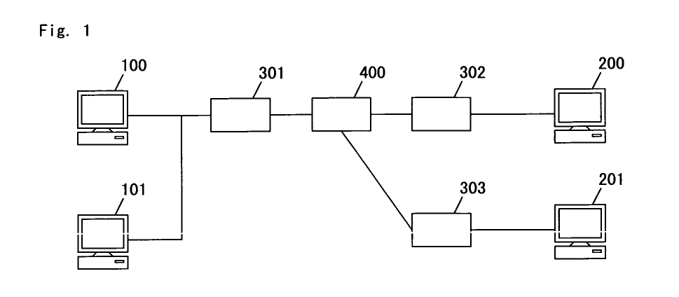

Referring to FIG. 1, a system according to a first embodiment is shown as an illustration. In FIG. 1, non-RSVP-adapted, communication terminals 100, 101, 200, and 201, and RSVP-adapted edge routers 301, 302, and 303 are illustrated.

The communication terminals 100, 101 are connected to the edge router 301. The communication terminals 200, 201 are connected to the edge routers 302, 303, respectively. The edge router 301 is connected to the other edge routers 302, 303 through a RSVP-adapted router 400.

In the system, assume that the flow to be guaranteed in quality are streamed from the communication terminal 100 to the communication terminal 200 through the edge router 301, the router 400, and the edger router 302. In this instance, in a network ranging from the edge router 301 to the edge router 302, network resources are reserved to provide the quality guarantee of the flow.

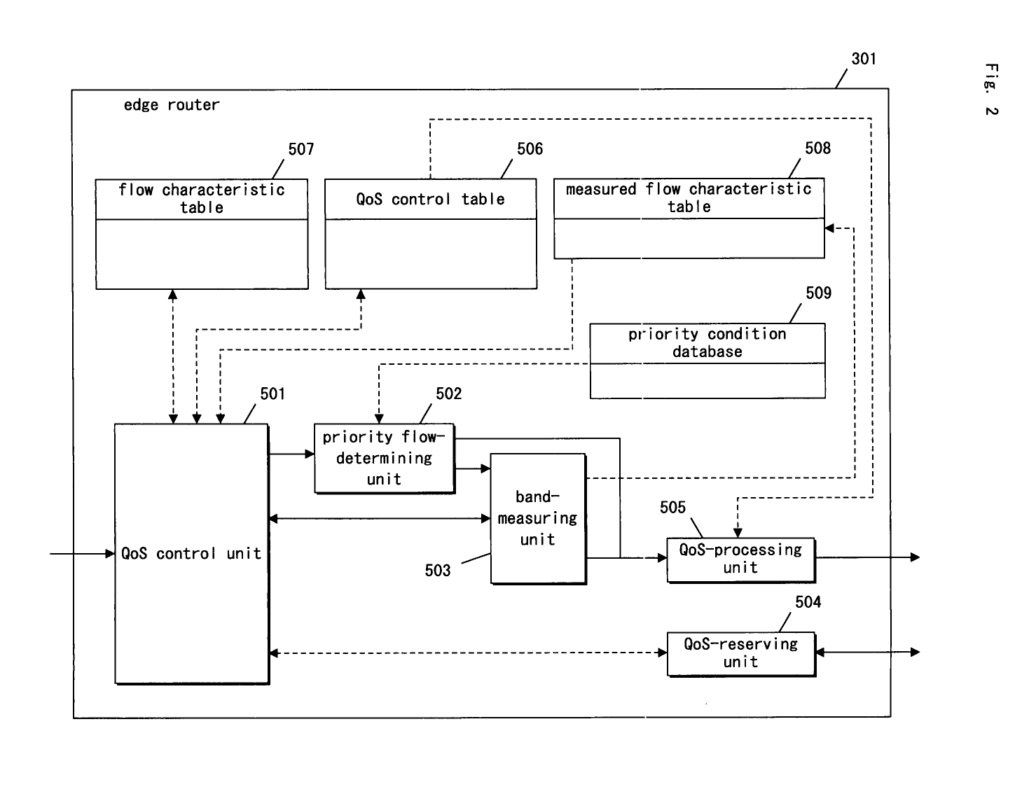

Referring now to FIG. 2, features in the edge router 301 are shown in functional diagram. The other edge routers 302, 303 are similar in construction to the edge router 301, and therefore descriptions related thereto are herein omitted.

As illustrated in FIG. 2, the edge router 301 includes a QoS-control unit 501, a priority flow-determining unit 502, a band-measuring unit 503, a QoS-reserving unit 504, a QoS-processing unit 505, a QoS control table 506, a flow characteristic table 507, a measured flow characteristic table 508, and a priority condition database 509.

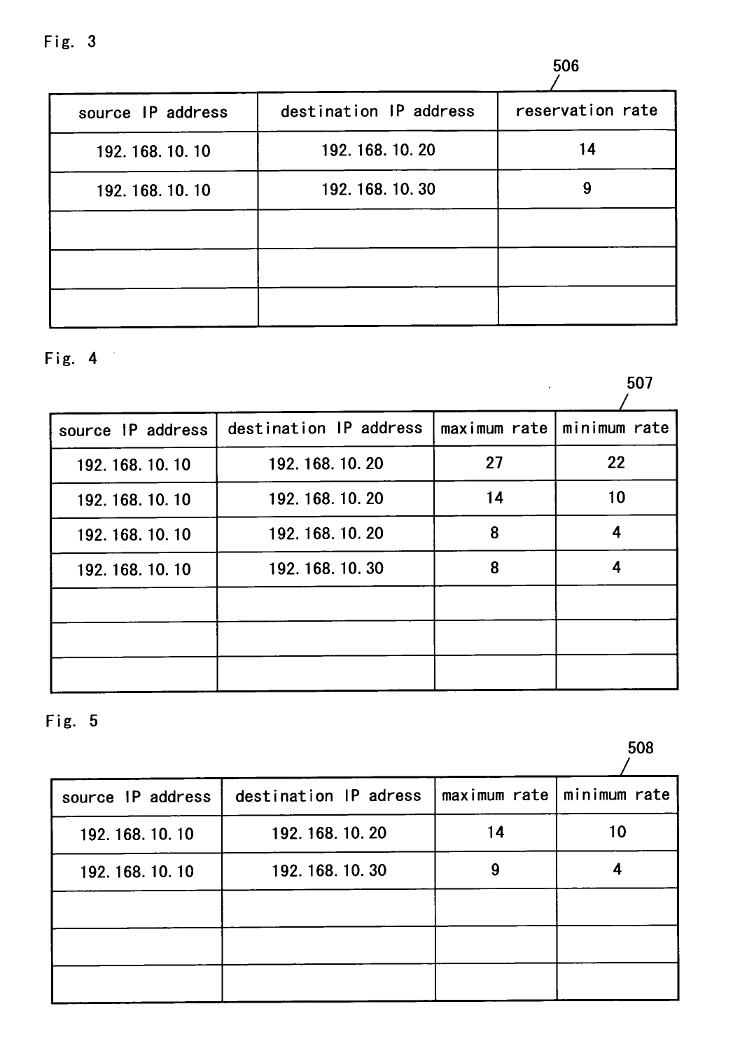

The QoS control table 506, flow characteristic table 507, and measured flow characteristic table 508 according to the present embodiment are illustrated in FIGS. 3, 4, and 5, respectively. The priority condition database 509 is illustrated in FIG. 6.

As illustrated in FIG. 3, the QoS control table 506 stores reservation parameters of the flow in which network resources are reserved. The QoS control unit 501 is operable to determine, with reference to the QoS control table 506, whether the current flow is to be QoS-controlled. The reservation parameters according to the present embodiment include a set of a source IP address, a destination IP address, and a reservation rate.

As illustrated in FIG. 4, the flow characteristic table 507 stores flow characteristic information previously measured by the band-measuring unit 503. As illustrated in FIG. 5, the measured flow characteristic table 508 stores flow characteristic information currently measured by the band-measuring unit 503. The QoS control unit 501 is operable to calculate the reservation parameters in accordance with the flow characteristic information from both of the flow characteristic table 507 and the measured flow characteristic table 508, thereby making a reservation. As a result, packet discard is arrested to provide guaranteed communication quality. The flow characteristic information according to the present embodiment includes a set of two different pieces of information, i.e., flow-identifying information including a source IP address and a destination IP address, and flow characteristic-indicating information such as a maximum rate and a minimum rate.

Alternatively, the flow characteristic information may include a MAC-address, a protocol, a port number, a flow label, an average rate, a maximum burst size, a maximum packet size, an average packet size, a maximum MTU value, and a minimum MTU value.

As illustrated in FIG. 6, the priority condition database 509 stores priority conditions related to the flow to be guaranteed in quality. The QoS control unit 501 is operable to guarantee the quality of the flow that meets the priority conditions. The priority conditions according to the present embodiment include a source IP address, a destination IP address, and a port number.

The value of the source IP address and that of the destination IP address show that the flow having such a source IP address and destination IP address is prioritized when the conditions in the priority condition database 509 are coincident with respective fields of a source IP address and a destination IP address of each input packet. The value of the port number is used at the header of the TCP or UDP protocol to identify the flow, and shows that the flow having such a port number is prioritized when the conditions in the priority condition database 509 are coincident with a port number of each input packet.

Alternatively, either flow-classifying information such as the protocol and the flow label or priority-indicating information such as DSCP, VLAN TCI.Priority may be used as the priority conditions. The flow label is a field used at the header of IPv6 (Internet Protocol version 6) to identify the flow. The DSCP is a field in an IP header for use in QoS control technology such as Diffserv. The VLAN TCI.Priority is a field in a VLAN header for use in VLAN or virtual LAN.

Pursuant to the present embodiment, the QoS control table 506, flow characteristic table 507, and measured flow characteristic table 508 are described as three different flow tables. Alternatively, they may be stored as a single table. As a further alternative, any known storage structure such as lists and arrays may be used instead of the tables.

The edge router 301 of FIG. 2 is now described in further detail.

The QoS control unit 501 is operable to execute three different steps of: transferring the flow that enters the edge router 301; addressing a request for reservation to the QoS-reserving unit 504; and managing both of the QoS control table 506 and the flow characteristic table 507.

According to the step of transferring the flow that enters the edge router 301, when the input flow is registered at either one of the QoS control table 506, the flow characteristic table 507, and the measured flow characteristic table 508, then the QoS control unit 501 transfers input flow-forming packets into the band-measuring unit 503. However, when the input flow is registered at none of the above tables, then the OoS control unit 501 transfers the input flow-forming packets into the priority flow-determining unit 502.

According to the step of addressing a request for reservation to the QoS-reserving unit 504, when the flow begins to enter the edge router 301, then the QoS control unit 501 calculates RSVP reservation parameters on the basis of the flow characteristic information from both of the flow characteristic table 507 and the measured flow characteristic table 508, thereby addressing a request for reservation to the QoS-reserving unit 504. When the entry of a certain flow into the edge router 301 is terminated, then the QoS control unit 501 addresses a request for reservation release to the QoS-reserving unit 504.

In the measured flow characteristic table 508, assume that the certain flow that continues to enter the edge router 301 is varied in value. In this instance, the QoS control unit 501 selects a value required by greater network resources, from both of the flow characteristic information at the flow characteristic table 507 and that at the measured flow characteristic table 508, thereby calculating the reservation parameters on the basis of the selected value. When the calculated reservation parameters are greater than the reserved reservation parameters, then the QoS control unit 501 addresses a request for reservation to the QoS-reserving unit 504. Pursuant to the present embodiment, the maximum rate in the flow characteristic information is a reservation rate in the reservation parameters.

The following discusses the step of managing both of the QoS control table 506 and the flow characteristic table 507. When the QoS control unit 501 is in receipt of a confirmed response to the request for network resource reservation from the QoS-reserving unit 504, then the reservation parameters requested for reservation by the QoS control unit 501 are registered into the QoS control table 506 by the QoS control unit 501. To address a request for reservation release to the QoS-reserving unit 504 from the QoS control table 501, the reservation parameters related to the requested reservation release are eliminated from the QoS control table 506 by the QoS control unit 501. At the end of the flow entry, the QoS control unit 501 compares the measured flow characteristic table 508 with the flow characteristic table 507 to renew required values.

Pursuant to the present embodiment, the flow characteristic table 507 is renewed in a manner given below. The QoS control unit 501 compares the flow characteristic information at the measured flow characteristic table 508 with that at the flow characteristic table 507.

Assume that the flow characteristic information at the flow characteristic table 507 has the same source IP address and the same destination IP address as those in the flow characteristic information at the measured flow characteristic table 508. Further assume that the flow characteristic information at the flow characteristic table 507 has a maximum rate-to-minimum rate range overlapped with that in the flow characteristic information at the measured flow characteristic table 508. In this instance, in the flow characteristic table 507, the overlapped maximum rate in the flow characteristic information is replaced, by the QoS control unit 501, by a greater value between the flow characteristic table 507 and the measured flow characteristic table 508, but the overlapped minimum rate in the flow characteristic information is replaced, by the QoS control unit 501, by a smaller value between the flow characteristic table 507 and the measured flow characteristic table 508.

The priority flow-determining unit 502 is operable to determine whether the input flow meets the priority conditions registered in the priority condition database 509. When the determination results in “YES” or when the input flow is to be prioritized, then the priority flow-determining unit 502 transfers the input flow into the band-measuring unit 503, but transfers the input flow into the QoS-processing unit 505 when the determination results in “NO” or when the input flow is to be non-prioritized. The priority conditions registered in the priority condition database 509 may be set during the manufacture of the network resource-reserving apparatus. Alternatively, the priority conditions may be set by users. As a further alternative, the priority conditions may be distributed via the network.

The band-measuring unit 503 is operable to measure bands of the input flow before transferring the input flow into the QoS-processing unit 505. When the measured flow characteristic information is unregistered at the measured flow characteristic table 508, the band-measuring unit 503 is operable to register the unregistered flow characteristic information into the measured flow characteristic table 508. When the measured flow characteristic information is registered at the measured flow characteristic table 508, the band-measuring unit 503 is operable to replace the current flow characteristic information at the measured flow characteristic table 508 by the measured flow characteristic information.

Upon receipt of the reservation parameters from the QoS control unit 501, the QoS-reserving unit 504 is operable to transmit reservation-requesting packets into a RSVP router. Upon receipt of reservation-confirming packets from the RSVP router, the QoS-reserving unit 504 notifies the QoS control unit 501 of such a confirmed response to the reservation. Upon receipt of a request for reservation release from the QoS control unit 501, the QoS-reserving unit 504 is operable to transmit reservation release-requesting packets into the router 400. The QoS-reserving unit 504 in receipt of reservation-requesting packets bound for the non-RSVP-adapted, communication terminal 100 is operable to transmit the reservation-confirming packets on behalf of the communication terminal 100.

Pursuant to the present embodiment, the reservation-requesting packet, reservation-confirming packet, and reservation release-requesting packet are a PATH-message, Resv-message, and PathTear-message, respectively. These messages are available in the RSVP protocol.

The QoS-processing unit 505 is operable to execute QoS control over the input flow in accordance with the reservation parameters at the QoS control table 506. The QoS control according to the present embodiment is concerned with a reservation rate band guarantee based on band control.

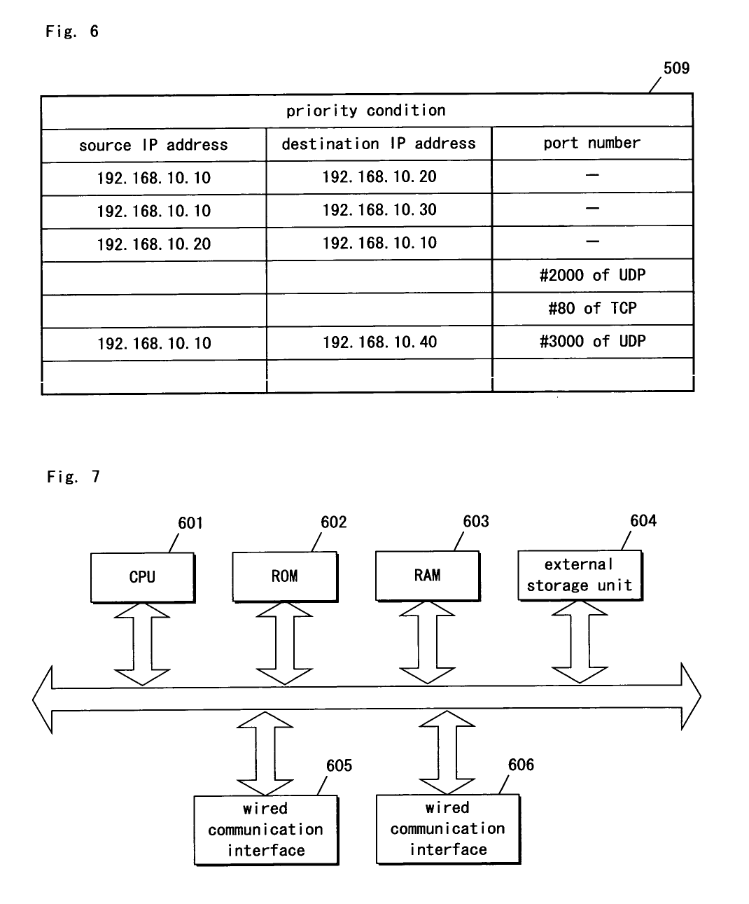

Referring now to FIG. 7, a hardware structure of the edge router 301 according to the present embodiment is shown as an illustration. The edge router 301 includes a CPU 601, a ROM 602, a RAM 603, an external storage unit 604, a wired communication interface 605, and a wired communication interface 606. The wired communication interface 605 may be, e.g., an Ethernet (R or a registered trademark) interface. The ROM 602 stores a program for controlling the edge router 301. The control program is read in by the RAM 603 at the time of activation. The RAM 603 provides a domain for the measured flow characteristic table 508 and that for the QoS control table 506. The external storage unit 604 provides a domain for the flow characteristic table 507 and that for the priority condition database 509.

To control each of the components, the CPU 601 is operated in accordance with programs in both of the ROM 602 and RAM 603, and the flow characteristic information in the external storage unit 604. The wired communication interfaces 605, 606 may be connected to a LAN-cable, and the flow to be guaranteed in quality enters the edge router 301 through the wired communication interface 605 that is connected to the communication terminals 100 and 101. The edge router 301 transfers the input flow through the wired communication interface 606, while executing QoS control over the input flow.

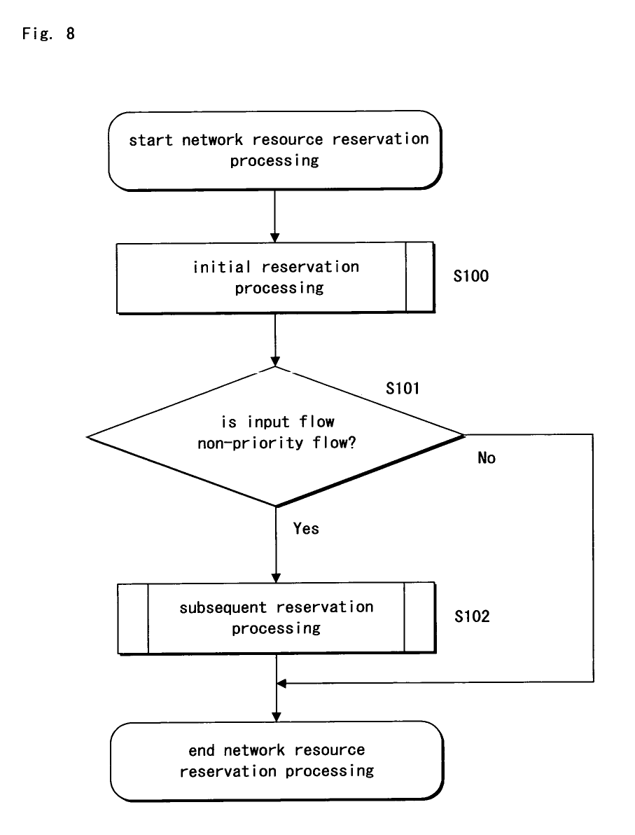

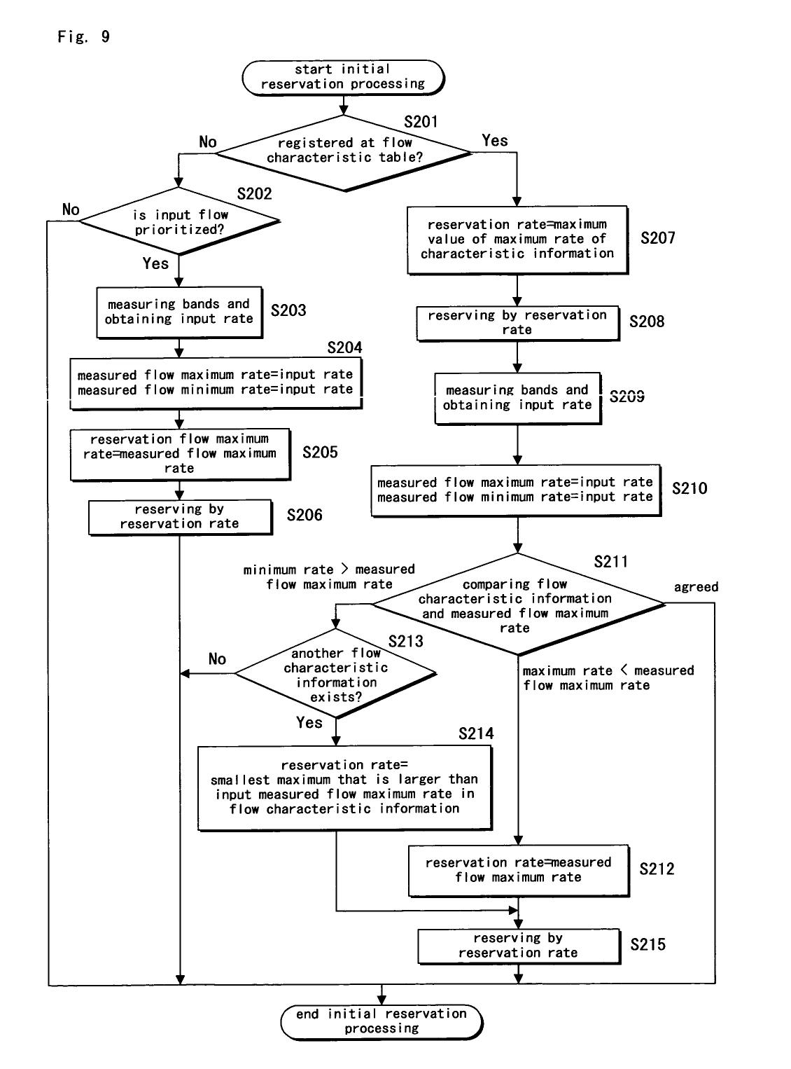

A course of action provided by the edge router according to the present embodiment is now described with reference to FIG. 8 to FIG. 10. Referring to FIG. 8, a flow of reservation processing executed by the edge router is schematically illustrated in flowchart form. Referring to FIG. 9, initial reservation processing as illustrated in FIG. 8 is illustrated in details. Referring to FIG. 10, subsequent reservation processing of FIG. 8 is illustrated in details.

Pursuant to the present embodiment, a rate measured by the band-measuring unit 503 is called an input rate, and the maximum and minimum rates in the flow characteristic information stored at the measured flow characteristic table 508 are called a measured flow maximum rate and a measured flow minimum rate, respectively.

The following outlines the network resource reservation processing practiced by the edge router 301. As illustrated in FIG. 8, at step S100, the edge router 301 practices the initial reservation processing when the flow begins to enter the edge router 301. At step S101, assume that the input flow is determined as priority flow in the initial reservation processing. In this instance, at step S102, the edge router 301 practices the subsequent reservation processing until the end of the flow entry. At the previous step S101, assume that the input flow is determined as non-priority flow. In this instance, the edge router 301 terminates the network resource reservation processing.

The initial reservation processing in step S100 is now described with reference to FIG. 9. At step S201, the QoS control unit 501 checks the input flow to determine whether a combination of a source IP address and a destination IP address thereof has been registered at the flow characteristic table 507.

When the determination in step S201 results in “NO”, then at step S202 the priority flow-determining unit 502 determines whether the input flow is to be prioritized. When the determination in step S202 results in “YES”, then at step S203 the band-measuring unit 503 measures bands of the input flow, and the QoS control unit 501 thereby obtains an input rate. At step S204, the QoS control unit 501 assigns the input rate value to a measured flow maximum rate and a measured flow minimum rate. At step S205, the QoS control unit 501 assigns the measured flow maximum rate value to a reservation rate, thereby feeding the reservation rate into the QoS-reserving unit 504. At step S206, the QoS-reserving unit 504 makes a request of the network for reservation in accordance with the reservation rate, thereby terminating the initial reservation processing. At the previous step S202, when the input flow is to be non-prioritized, then the QoS control unit 501 terminates the initial reservation processing without making a reservation.

At the previous step S201, when the source IP address and destination IP address of the input flow has been registered at the flow characteristic table 507, then at step S207, the maximum value among maximum rates in several pieces of flow characteristic information having the same combination of the source IP address and destination IP address as that of the input flow is taken as a network resource reservation rate by the QoS control unit 501, and the reservation rate is fed into the QoS-reserving unit 504. At step 208, the QoS-reserving unit 504 makes a request of the network for reservation in accordance with the reservation rate. At step S209, the band-measuring unit 503 measures the bands of the input flow to permit the QoS control unit 501 to obtain an input rate. At step S210, the QoS control unit 501 assigns the input rate value into a measured flow maximum rate and a measured flow minimum rate.

Ate step S211, the QoS control unit 501 compares the maximum rate in the flow characteristic information used for the reservation with the measured flow maximum rate.

When the comparison in step S211 shows that the measured flow maximum rate is greater than the maximum rate in the flow characteristic information used for the reservation, then the QoS control unit 501 assigns the measured flow maximum rate to a reservation rate, thereby feeding the reservation rate into the QoS-reserving unit 504. At step S215, the QoS-reserving unit 504 makes a request of the network for reservation in accordance with the reservation rate, thereby terminating the initial reservation processing.

When the comparison in the previous step S211 shows that the measured flow maximum rate falls within the range between the maximum rate and the minimum rate in the flow characteristic information used for the reservation, then the QoS control unit 501 determines that the input flow meets the flow characteristic information used for the reservation, and terminates the initial reservation processing. When the comparison in the previous step S211 shows that the measured flow maximum rate is smaller than the minimum rate in the flow characteristic information used for the reservation, then at step S213, the QoS control unit 501 checks the flow characteristic table 507 to determine whether there is other flow characteristic information having the same combination of the source IP address and destination IP address as that of the input flow. When the determination in step S213 results in “NO”, then the QoS control unit 501 terminates the initial reservation processing. When the determination in step S213 results in “YES”, then at step S214, the smallest maximum rate value in several pieces of flow characteristic information having maximum rates greater than the measured flow maximum rate is identified as a reservation rate by the QoS control unit 501, and the reservation rate is fed into the QoS-reserving unit 504. At step S215, the QoS-reserving unit 504 makes a request of the network for reservation in accordance with the reservation rate.

The subsequent reservation processing after the initial reservation processing is now described with reference to FIG. 10.

At initial step S301, the band-measuring unit 503 measures the bands of the input flow to permit the QoS control unit 501 to obtain an input rate. At step S302, a greater value between the measured flow maximum rate and the input rate is entered into the measured flow maximum rate by the QoS control unit 501, while a smaller value between the measured flow minimum rate and the input rate is entered into the measured flow minimum rate by the QoS control unit 501. At step S303, the QoS control unit 501 compares the measured flow maximum rate with the reservation rate. When the comparison in step S303 shows that the measured flow maximum rate is greater than the reservation rate, then at step S304, the QoS control unit 501 assigns the measured flow maximum rate to the reservation rate, thereby feeding the reservation rate into the QoS-reserving unit 504. At step S305, the QoS-reserving unit 504 makes a request of the network for reservation in accordance with the reservation rate.

When the comparison in the previous step S303 shows that the measured flow maximum rate is equal or smaller than the reservation rate, then at step S306, the QoS control unit 501 determines whether the flow entry has been terminated. When the determination in step S306 results in “NO”, the routine is returned to the previous step S301. When the determination in step S306 results in “YES”, then the routine is advanced to step S307 at which the measured flow characteristic table 508 is compared with the flow characteristic table 507.

At step S307, assume that the flow characteristic table 507 possesses flow characteristic information having the same combination of the source IP address and destination IP address as that of the flow characteristic information at the measured flow characteristic table 508, and having a maximum rate-to-minimum rate range overlapped with that of the flow characteristic information at the measured flow characteristic table 508. In this instance, at step S308, the QoS control unit 501 renews the flow characteristic table 507 to take a logical sum of the overlapped rate range of the flow characteristic information. More specifically, the QoS control unit 501 compares the overlapped maximum rate in the flow characteristic information at the flow characteristic table 507 with the measured flow maximum rate, thereby renewing the flow characteristic table 507 in accordance with a greater value between the compared maximum rates. In addition, the QoS control unit 501 compares the overlapped minimum rate in the flow characteristic information at the flow characteristic table 507 with the measured flow minimum rate, thereby renewing the flow characteristic table 507 in accordance with a smaller value between the compared minimum rates.

Assume that there are several pieces of flow characteristic information having maximum rate-to-minimum rate ranges overlapped with the range between the measured flow maximum rate and the measured flow minimum rate. In this situation, the QoS control unit 501 eliminates all pieces of the overlapped flow characteristic information, but selects the greatest value from among the flow characteristic information maximum rates overlapped with the measured flow maximum rate as well as the smallest value from among the flow characteristic information minimum rates overlapped with the measured flow minimum rate. The QoS control unit 501 registers the selected rates as new flow characteristic information into the flow characteristic table 507.

When the assumption in the previous step S307 is unapplied, then at step S309, a new entry is added to the flow characteristic table 507 in accordance with the measured flow maximum rate and measured flow minimum rate. The subsequent reservation processing is terminated at the end of either step S308 or step S309.

At the previous step S307, assume that the measured flow maximum and minimum rates are equivalent to the overlapped flow characteristic information maximum and minimum rates, respectively. In this instance, the QoS control unit 501 terminates the subsequent reservation processing without renewing the flow characteristic table 507.

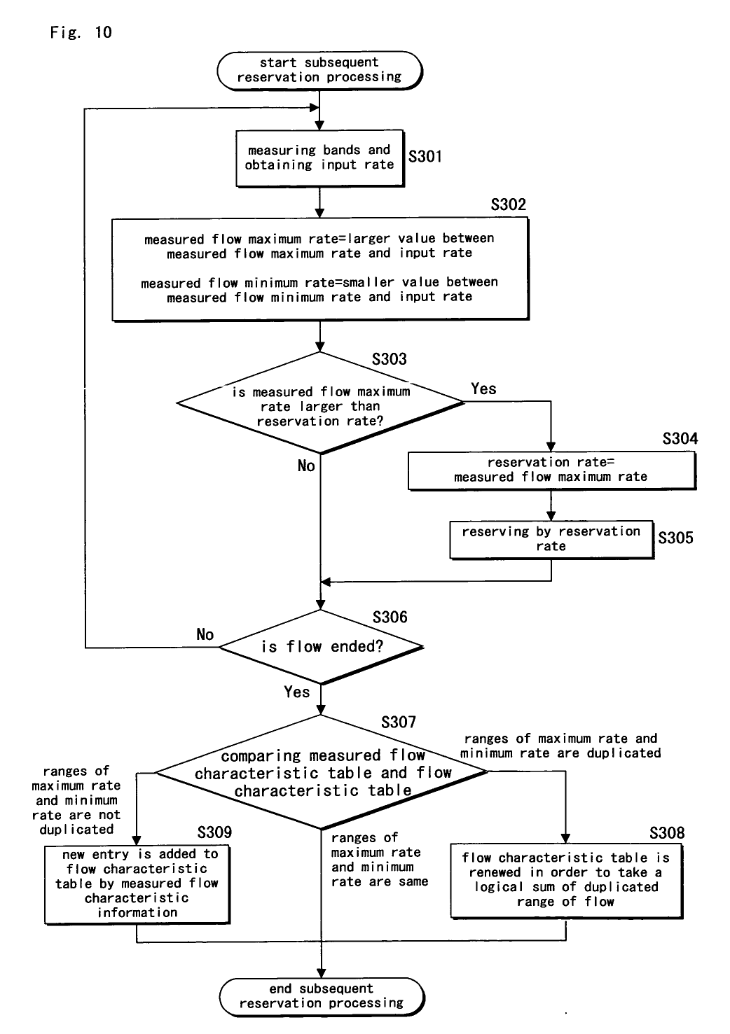

The following discusses, with reference to FIG. 11 to FIG. 13, the way in which flow characteristic information of flow 1 having the source IP address 192.168.10.10 to the destination IP address 192.168.10.20, and having the maximum rate 27 Mbps and the minimum rate 22 Mbps is newly registered into the flow characteristic table 507, on the assumption that flow 1 is streamed when no flow characteristic information is registered at the flow characteristic table 507.

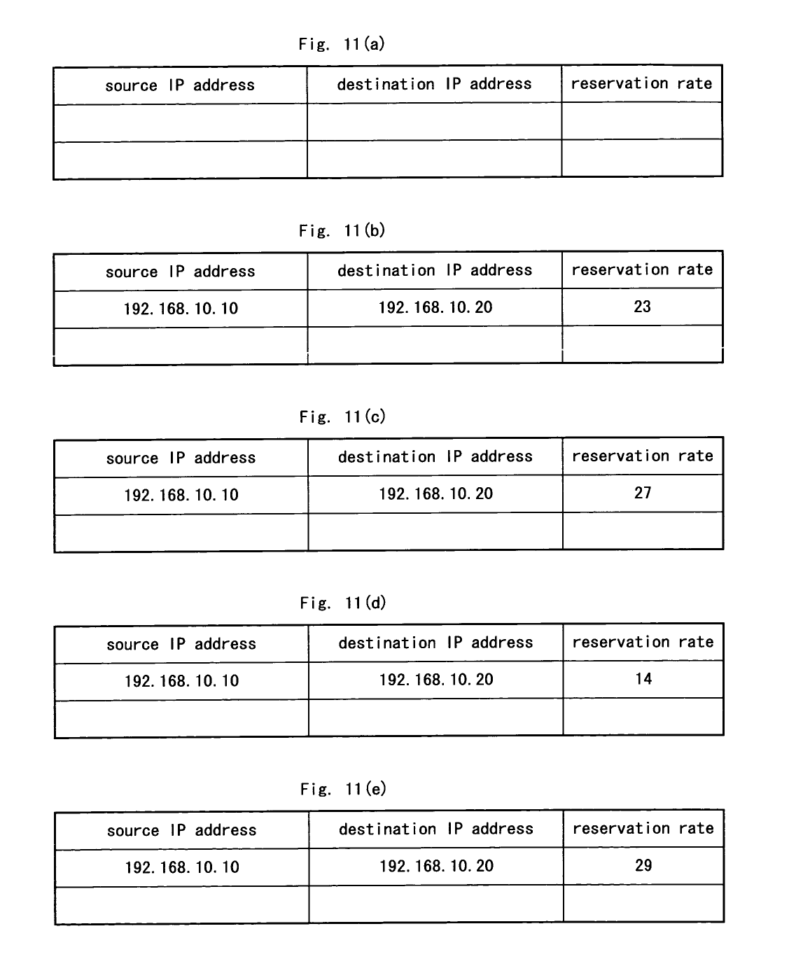

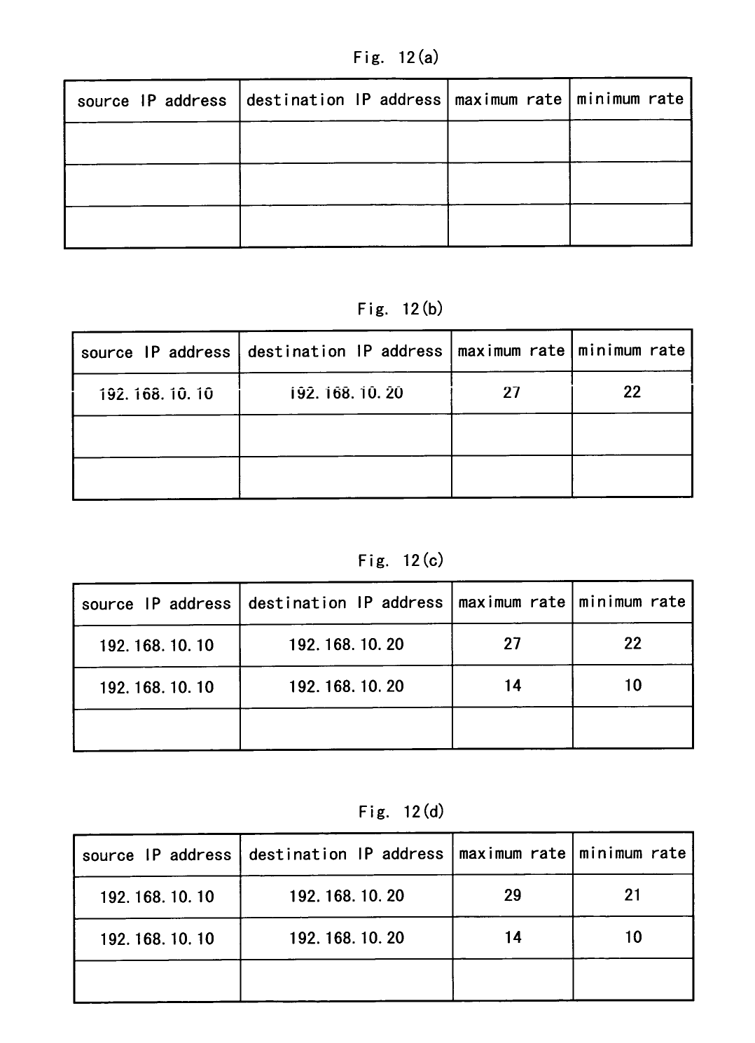

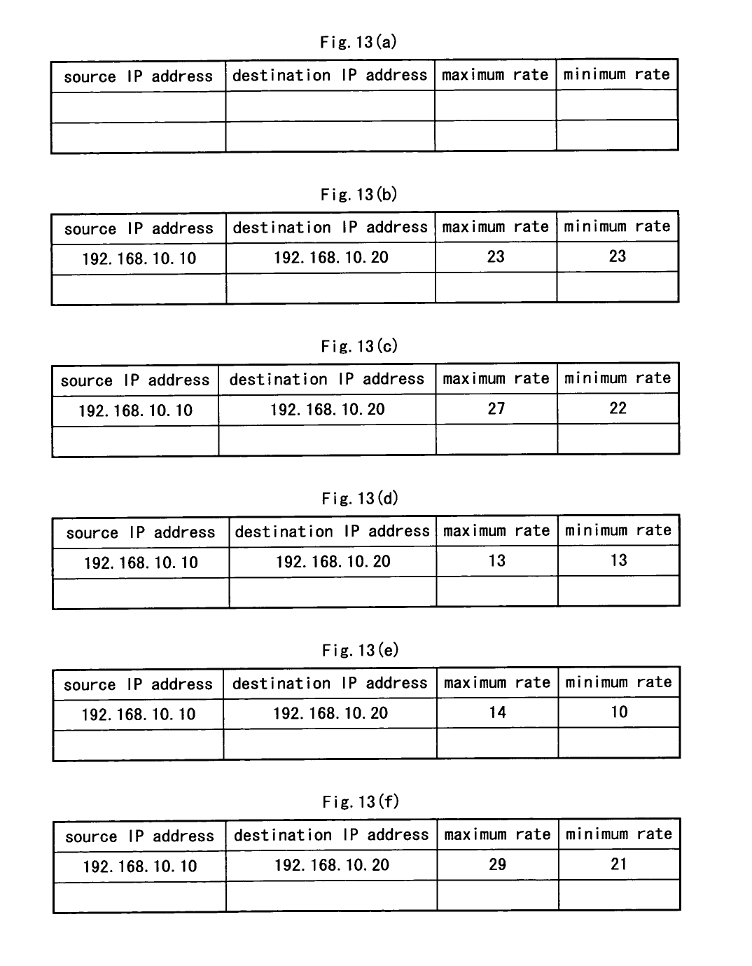

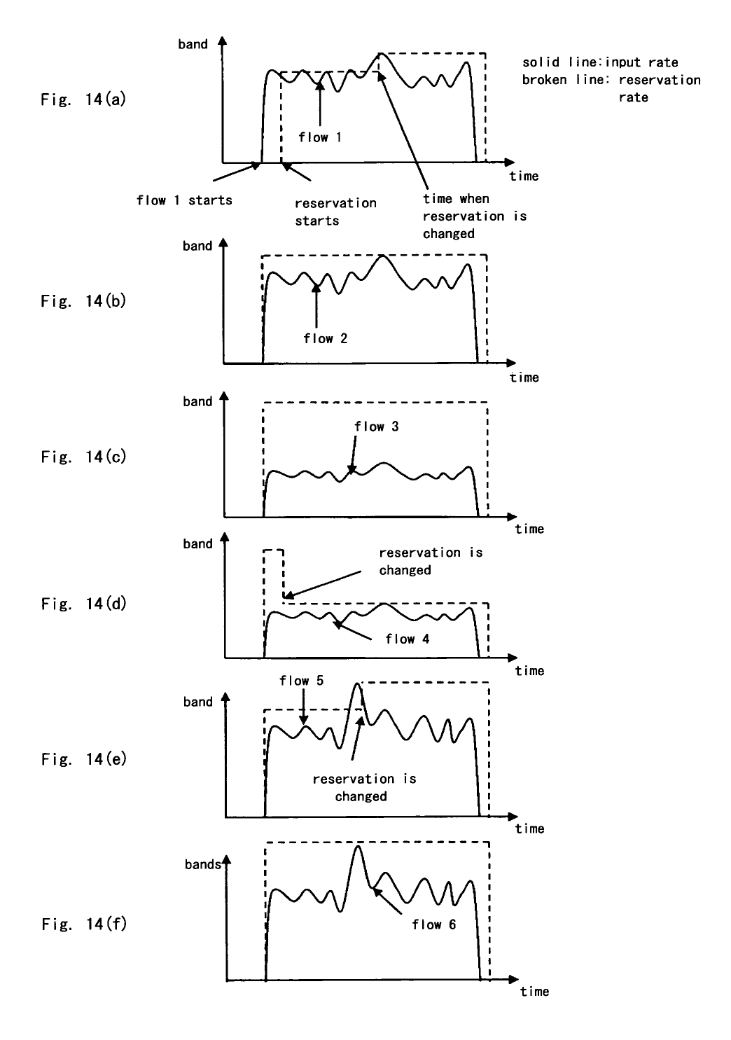

In the edge router 301 before the stream of flow 1, the QoS control table 506, flow characteristic table 507, and measured flow characteristic table 508 are void as illustrated in FIG. 11(a), FIG. 12(a), and FIG. 13(a), respectively.

When flow 1 initially enters the edge router 301, then at step S201, flow characteristic information having a combination of a source IP address and a destination IP address coincident with that of flow 1 is stored at neither the flow characteristic table 507 of FIG. 12(a) nor the QoS control table 506 of FIG. 11(a), and the QoS control unit 501 transfers the input flow into the priority flow-determining unit 502. At step S202, the priority flow-determining unit 502 judges whether flow 1 meets the conditions registered in the priority condition database 509 of FIG. 6. The conditions “192.168.10.10” and “192.168.10.20” related to flow 1 conform to the corresponding conditions of “the source IP address” and “the destination IP address” registered in the priority condition database 509 of FIG. 6, and consequently flow 1 is treated as being prioritized. As a result, flow 1 is transferred from the priority flow-determining unit 502 into the band-measuring unit 503. After passing through the band-measuring unit 503, flow 1 is transferred through the QoS-processing unit 505, but flow 1 does not enjoy the band control-based quality guarantee until the network resources are reserved after the measurement of the bands of flow 1.

At step S203, the band-measuring unit 503 measures an input rate of flow 1. At step S204, the QoS control unit 501 registers the flow characteristic information into the measured flow characteristic table 508 of FIG. 13(b). At subsequent step S205, the QoS control unit 501 calculates reservation parameters based on the registered flow characteristic information at the measured flow characteristic table 508 of FIG. 13(b), thereby addressing a request for reservation to the QoS-reserving unit 504. Pursuant to the present embodiment, a reservation rate in the reservation parameters is set as 23 Mbps on the basis of the maximum rate 23 Mbps in the flow characteristic information at the measured flow characteristic table 508 of FIG. 13(b). At step S206, the router 400 on the pathway of flow 1 is requested by the QoS-reserving unit 504 to reserve the network resources in accordance with the requested reservation parameters. Upon receipt of reservation-confirming packets from the router 400, the QoS-reserving unit 504 notifies the QoS control unit 501 of the confirmed response to the reservation. Upon receipt of such notification from the QoS-reserving unit 504, the QoS control unit 501 registers the reservation parameters into the QoS control table 506 of FIG. 11(b). Subsequently, the QoS-processing unit 505 executes QoS control over flow 1 with reference to the registered reservation parameters at the QoS control table 506 of FIG. 11(b). As a result, a band guarantee from the edge router 301 to the edge router 302 is achievable to guarantee the quality of flow 1.

At step S301, the band-measuring unit 503 continues to measure the bands of flow 1 until the end of the stream of flow 1. At step S302, the flow character information of flow 1 at the measured flow characteristic table 508 is renewed as illustrated in FIG. 13(c). At step S303, assume that the increased maximum rate at the renewed measured flow characteristic table 508 of FIG. 13(c) fails to guarantee the quality of flow 1 in accordance with the reserved network resources. In this instance, at step S304, the QoS control unit 501 calculates reservation parameters based on the renewed flow characteristic information at the measured flow characteristic table of FIG. 13(c), thereby again requesting the QoS-reserving unit 504 to reserve the network resources in accordance with the calculated reservation parameters. In response to the request for re-reservation from the QoS control unit 501, at step S305, the router 400 on the pathway of flow 1 is requested for the re-reservation by the QoS-reserving unit 504, thereby renewing the QoS control table 506, as illustrated in FIG. 11(c). As a result, the varied flow 1 can be taken care of to continuously guarantee the quality of flow 1. Pursuant to the present embodiment, the reservation rate is changed from 23 Mbps at the QoS control table 506 of FIG. 11(b) to 27 Mbps in accordance with the maximum rate 27 Mbps at the measured flow characteristic table 508 of FIG. 13(c). As a result, the re-reservation is executable as illustrated in FIG. 11(c).

At step S306, the stream of flow 1 is terminated. A step S307, the QoS control unit 501 checks the flow characteristic table 507 of FIG. 12(a) to determine whether there is flow characteristic information having a maximum rate-to-minimum rate range overlapped with that of the flow characteristic information of flow 1 at the measured flow characteristic table 508 of FIG. 13(c). Since there is no overlapped flow characteristic information registered at the flow characteristic table 507 of FIG. 12(a), at step S309, the QoS control unit 501 registers the flow characteristic information of flow 1 into the flow characteristic table 507 of FIG. 12(b). The QoS control unit 501 eliminates the reservation parameters of flow 1 from the QoS control table 506, as illustrated in FIG. 11(a), and eliminates the flow characteristic information of flow 1 from the measured flow characteristic table 508, as illustrated in FIG. 13(a).

As illustrated in FIG. 12(b), the flow characteristic information of flow 1 has been registered at the flow characteristic table 507, and when the flow having the same flow characteristic information as that of flow 1 is streamed, then packet discard is suppressed to provide the quality guarantee of the flow.

The following discusses the way of treating flow 2 having the same flow characteristic information as that of flow 1, on the assumption that flow 2 is streamed, while the measured flow characteristic information of flow 1 is used, during the measurement of the flow characteristic information of flow 1 in the edge router 301.

In the edge router 301 before the stream of flow 2, the QoS control table 506, flow characteristic table 507, and measured flow characteristic table 508 are as illustrated in FIG. 11(a), FIG. 12(b), and FIG. 13(a), respectively.

When flow 2 begins to stream, then at step S201, the flow characteristic information having the same combination of the source IP address and the destination IP address as that of flow 2 is stored at the flow characteristic table 507 of FIG. 12(b). At step S207, the QoS control unit 501 calculates reservation parameters based on the stored flow characteristic information at the flow characteristic table 507 of FIG. 12(b). At step 208, the QoS control unit 501 addresses a request for reservation to the QoS-reserving unit 504. Pursuant to the present embodiment, a reservation rate in the reservation parameters is set as 27 Mbps in accordance with the maximum rate 27 Mbps at the flow characteristic table 507 of FIG. 12(b). Flow 2 is transferred to the band-measuring unit 503. After passing through the band-measuring unit 503, flow 2 is transferred through the QoS-processing unit 505. Different from the streaming flow 1, there is no need to measure the bands of flow 2 by the time when the network resources are reserved. As a result, a prompt reservation can be made to provide the prompt quality guarantee of flow 2. More specifically, flow 2 including the heads thereof is transferred in a state of being reserved, and when flow 2 is a flow of moving pictures, image quality at the heads thereof is never degraded.

Pursuant to the present embodiment, when the flow begins to stream, the network resources are reserved on the basis of the greatest maximum rate values in the several pieces of flow characteristic information registered at the flow characteristic table 507. Alternatively, the reservation may be made on the basis of the greatest network resources available in the network (all network resources remaining at that time). As a further alternative, the network resources used for the reservation may be an expected maximum rate such as, e.g., 24 Mbps in HDTV. In this way, even when any flow begins to flow, the quality guarantee of the flow is achievable.

Upon receipt of the reservation-confirming packets from the router 400 on the pathway of flow 2, the QoS-reserving unit 504 notifies the QoS control unit 506 of the confirmed reservation. As illustrated in FIG. 11(c), the QoS control unit 501 adds the reserved reservation parameters to the QoS control table 506. The QoS-processing unit 505 executes band control with reference to the registered reservation parameters at the QoS control table 506 of FIG. 11(c), thereby providing the QoS control over flow 2.

At step S209, the band-measuring unit 503 measures bands of flow 2. At step S210, results from the band measurement are registered into the measured flow characteristic table 508 of FIG. 13(b). At step S211, the QoS control unit 501 compares the measured flow maximum rate with the maximum rate in the flow characteristic information used for the reservation. Referring to the flow characteristic table 507 of FIG. 12(b), the range of the maximum rate 27 Mbps to the minimum rate 22 Mbps in the flow characteristic information used for the reservation includes the range of the maximum rate 23 Mbps to the minimum rate 23 Mbps as illustrated in FIG. 13(b), and the QoS control unit 501 makes no change in reservation. At step S301, the band-measuring unit 503 continues to measure the bands of flow 2. At step S302, the flow characteristic information of flow 2 remains stored at the measured flow characteristic table 508 of FIG. 13(c). At step S303, there is a stream of the flow having the same flow characteristic information as that registered at the flow characteristic table 507, and a re-reservation need not be made in response to an increase in band, as opposed to flow 1. As a result, the quality guarantee of flow 2 is achievable, which includes packets that, in case of flow 1, would possibly be discarded until the re-reservation is made. Pursuant to the present embodiment, as illustrated in FIG. 12(b), the maximum and minimum rates of the flow characteristic information at the flow characteristic table 507 ranges from 27 Mbps to 22 Mbps, which is the same as the maximum-to-minimum rate range at the measured flow characteristic table 508 of FIG. 13(c), and consequently no re-reservation is required.

At step S306, the stream of flow 2 is terminated. At step S307, the QoS control unit 501 checks the flow characteristic table 507 of FIG. 12(b) to determine whether there is flow characteristic information having a maximum rate-to-minimum rate range overlapped with that of the flow characteristic information of flow 2 at the measured flow characteristic table 508 of FIG. 13(c). The determination in step S307 shows that the same flow characteristic information as that of flow 2 at the measured flow characteristic table of FIG. 13(c) is stored at the flow characteristic table 507 of FIG. 12(b). Accordingly, the QoS control unit 501 allows the flow characteristic table 507 to remain unchanged. The QoS control unit 501 eliminates the reservation parameters of flow 2 from the QoS control table 506, as illustrated in FIG. 11(a), and eliminates the flow characteristic information of flow 2 from the measured flow characteristic table 508, as illustrated in FIG. 13(a).

The following discusses the way of treating flow 3 having flow characteristic information in which a maximum rate is smaller than the minimum rate in the flow characteristic information of flow 1, having the source IP address 192.168.10.10 to the destination IP address 192.168.10.20, and having the maximum rate 14 Mbps and the minimum rate 10 Mbps, on the assumption that the flow 3 is streamed when the edge router 301 is measuring the flow characteristic information of flow 1 and that of flow 2. The following further discusses the way in which the flow characteristic information of flow 3 is added to the flow characteristic table 507.

In the edge router 301 before the stream of flow 3, the QoS control table 506, flow characteristic table 507, and measured flow characteristic table 508 are as illustrated in FIG. 11(a), FIG. 12(b), and FIG. 13(a), respectively.

The flow characteristic information of flow 3 remains unknown until the band-measuring unit 503 measures bands of flow 3 after flow 3 begins to stream. Similarly to the start of the stream of flow 2, at step S201, S207, and S208, the QoS control unit 501 allows the QoS-reserving unit 504 to reserve the network resources in accordance with reservation parameters calculated on the basis of the flow characteristic information stored at the flow characteristic table 507 of FIG. 12(b). The reservation parameters are registered into the QoS control table 506. Pursuant to the present embodiment, the maximum rate 27 Mbps is the greatest maximum rate value in the flow characteristic information at the flow characteristic table 507 of FIG. 12(b), and a reservation rate is set as 27 Mbps. At step S209, the band-measuring unit 503 measures the bands of flow 3, and at step S210, the flow characteristic information of flow 3 is stored at the measured flow characteristic table 508 of FIG. 13(d).

At step S211, it is found that the measured flow maximum rate 13 Mbps at the measured flow characteristic table 508 of FIG. 13(d) is smaller than the minimum rate 22 Mbps in the flow characteristic information at the flow characteristic table 507 used for the reservation (see FIG. 12(b)). At step S213, the QoS control unit 501 checks the flow characteristic table 507 to determine whether there is other flow characteristic information. Since other flow characteristic information is absent, the QoS control unit 501 makes no change in reservation. At step S301, the band-measuring unit 503 continues to measure the bands of flow 3, and at step S302, the flow characteristic information of flow 3 is continuously stored at the measured flow characteristic table 508 of FIG. 13(e). At step S303, the quality guarantee of flow 3 based on the reserved reservation rate 27 Mbps is achievable, and no re-reservation is made.

At step S306, the stream of flow 3 is terminated. At step S307, the QoS control unit 501 checks the flow characteristic table 507 of FIG. 12(b) to determine whether there is flow characteristic information overlapped with the flow characteristic information of flow 3 at the measured flow characteristic table 508 of FIG. 13(e). Since the overlapped flow characteristic information is unregistered, at step S309, the QoS control unit 501 adds the flow characteristic information of flow 3 to the flow characteristic table 507, as illustrated in FIG. 12(c). According to the present embodiment, the range of the maximum rate 27 Mbps to the minimum rate 22 Mbps in the flow characteristic information at the flow characteristic table 507 of FIG. 12(b) is non-overlapped with the range of the maximum rate 14 Mps to the minimum rate 10 Mbps in the flow characteristic information of flow 3 at the measured flow characteristic table 508 of FIG. 13(e). Accordingly, the QoS control unit 501 newly adds the flow characteristic information of flow 3 to the flow characteristic table 507.

The QoS control unit 501 eliminates the reservation parameters of flow 3 from the QoS control table 506, as illustrated in FIG. 11(a), and eliminates the flow characteristic information of flow 3 from the measured flow characteristic table 508, as illustrated in FIG. 13(a).

As discussed above, the flow characteristic information of flow 3 has newly been registered at the flow characteristic table 507. Accordingly, when the flow having the same flow characteristic information as that of flow 3 is streamed, then the reservation parameters of flow 3 can be used to make a reservation. Consequently, a difference in network resources between flow 1 and flow 3 can be allocated to other flows. As a result, the efficient use of the network resources is realized. According to the present embodiment, the maximum rate of flow 1 and that of flow 3 are 27 Mbps and 14 Mbps, respectively, and the difference 13 Mbps therebetween can operatively be allocated to other flows.

The following discusses the way of treating flow 4 having the same flow characteristic information as that of flow 3, having the source IP address 192.168.10.10 to the destination IP address 192.168.10.20, and having the maximum rate 14 Mbps and the minimum rate 10 Mbps, on the assumption that flow 4 is streamed when the edge router 301 is measuring the respective pieces of flow characteristic information of flow 1, flow 2, and flow 3.

In the edge router 301 before the stream of flow 4, the QoS control table 506, flow characteristic table 507, and measured flow characteristic table 508 are as illustrated in FIG. 11(a), FIG. 12(c), and FIG. 13(a), respectively.

The flow characteristic information of flow 4 such as its maximum rate remains unknown until bands of flow 4 are measured by the band-measuring unit 503 after flow 4 begins to stream. Similarly to flow 3, at step S201 and S207, the QoS control unit 501 selects flow characteristic information having the greatest maximum rate value from among several pieces of flow characteristic information at the flow characteristic table 507 in order to calculate reservation parameters. At step S208, the QoS control unit 501 allows the QoS-reserving unit 504 to reserve the network resources in accordance with the calculated reservation parameters. The reservation parameters are registered into the QoS control table 506, as illustrated in FIG. 11(c). At step S209, the band-measuring unit 503 measures bands of flow 4, and at step S210, the flow characteristic information of flow 4 is saved into the measured flow characteristic table 508, as illustrated in FIG. 13(d).

At step S211, the QoS control unit 501 compares the flow characteristic information of flow 4 at the measured flow characteristic table 508 of FIG. 13(d)) with the flow characteristic information used for the reservation at the flow characteristic table 507 of FIG. 12(c). Since the measured flow maximum rate 13 Mbps is smaller than the minimum rate 22 Mbps in the flow characteristic information used for the reservation, at step S213, the QoS control unit 501 checks the flow characteristic table 507 to determine whether there is other flow characteristic information. The maximum rate 14 Mbps in the flow characteristic information of flow 3 at the flow characteristic table 507 of FIG. 12(c) is greater than the maximum rate 13 Mbps at the measured flow characteristic table 508 of FIG. 13(d), but is the smallest maximum rate value. At steps S214 and S215, the QoS control unit 501 allows the QoS-reserving unit 504 to make a re-reservation in accordance with the maximum rate of flow 3.

The re-reservation according to the maximum rate 14 Mbps of flow 3 provides more network resources allocable to other flows, and the efficient use of the network resources is achievable.

At step S301, the band-measuring unit 503 continues to measure the bands of flow 4 after the re-reservation. At step S302, the flow characteristic information at the measured flow characteristic table 508 is renewed as illustrated in FIG. 13(e). At step S303, the quality guarantee of flow 4 based on the reserved reservation parameters is achievable until the end of the stream of flow 4, and no re-reservation is newly made.

Similarly to flow 2, at steps S306 and S307, the flow characteristic table 507 remains unchanged after the end of the stream of flow 4. The QoS control unit 501 eliminates the reservation parameters of flow 4 from the QoS control table 506, as illustrated in FIG. 11(a), and eliminates the flow characteristic information of flow 4 from the measured flow characteristic table 508, as illustrated in FIG. 13(a).

The following discusses the way of treating flow 5 having flow characteristic information overlapped with that of flow 1, having the source IP address 192.168.10.10 to the destination IP address 192.168.10.20, and having the maximum rate 29 Mbps and the minimum rate 21 Mbps, on the assumption that flow 5 is streamed when the edge router 301 is measuring the respective pieces of flow characteristic information of flow 1, flow 2, flow 3, and flow 4.

In the edge router 301 before the stream of flow 5, the QoS control table 506, flow characteristic table 507, and measured flow characteristic table 508 are as illustrated in FIG. 11(a), FIG. 12(c), and FIG. 13(a), respectively.

Similarly to the start of the stream of flow 4, when flow 5 begins to stream, then at steps S201, S207, and S208, the QoS control unit 501 allows the QoS-reserving unit 504 to make a reservation in accordance with the reservation rate 27 Mbps, which is one of the reservation parameters in the flow characteristic information having the greatest maximum rate value among the several pieces of flow characteristic information stored at the flow characteristic table 507. As illustrated in FIG. 11(e), the reservation rate is registered into the QoS control table 506. At step S209, the band-measuring unit 503 measures bands of flow 5, and at step S210, the flow characteristic information of flow 5 is saved into the measured flow characteristic table 508, as illustrated in FIG. 13(b). At step S211, no change in reservation is made because the range of the maximum rates 27 Mpbs to 22 Mbps in the flow characteristic information used for the reservation includes the range of 23 Mbps to 23 Mbps in the flow characteristic information at the measured flow characteristic table 508.

At step S301, the band-measuring unit 503 continues to measure the bands of flow 5, and at step S302, the flow characteristic information of flow 5 is saved into the measured flow characteristic table 508, as illustrated in FIG. 13(f). At step S303, as illustrated in FIG. 13(f), assume that the maximum rate of flow 5 is increased to exceed the maximum rate 27 Mbps in the flow characteristic information used for the reservation. In this instance, at step S304, the QoS control unit 501 re-calculates reservation parameters on the basis of the flow characteristic information at the renewed measured flow characteristic table 508 of FIG. 13(f). At step S305, the QoS control unit 501 allows the QoS-reserving unit 504 to make a re-reservation as illustrated in FIG. 11(e). According to the present embodiment, the quality of flow 5 cannot be guaranteed based on the reservation rate 27 Mbps of flow 1 at the flow characteristic table 507 of FIG. 12(c), and the maximum rate 29 Mbps at the renewed measured flow characteristic table 508 of FIG. 13(f) is taken as a reservation rate as illustrated in FIG. 11(e) to make a reservation. As a result, the quality of flow 5 is successfully guaranteed.

At step S306, the stream of flow 5 is terminated. At step S307, the QoS control unit 501 checks the flow characteristic table 507 of FIG. 12(c) to determine whether there is flow characteristic information overlapped with the flow characteristic information of flow 5 at the measured flow characteristic table 508 of FIG. 13(f). The overlapped flow characteristic information has been registered, and a comparison is made between the maximum rates in the overlapped flow characteristic information, thereby showing that the maximum rate 29 Mbps at the measured flow characteristic table 508 of FIG. 13(f) is greater than the maximum rate 27 Mbps at the flow characteristic table 507 of FIG. 12(c). A comparison is made between the minimum rates in the overlapped flow characteristic information, thereby showing that the minimum rate 21 Mbps at the measured flow characteristic table 508 of FIG. 13(f) is smaller than the minimum rate 22 Mbps at the flow characteristic table 507 of FIG. 12(c). As illustrated in FIG. 12(d), at step S308, the QoS control unit 501 replaces the maximum and minimum rates in the overlapped flow characteristic information at the flow characteristic table 507 of FIG. 12(c) by the maximum rate 29 Mbps and the minimum rate 21 Mbps at the measured flow characteristic table 508 of FIG. 13(f), respectively. The replacement is made in accordance with the selection of a greater range of a maximum rate to a minimum rate in the flow characteristic information.

Assume that the flow characteristic table 507 contains one piece of flow characteristic information having a maximum-to-minimum rate range overlapped with that of another piece of flow characteristic information. In this situation, one flow having the former piece of flow characteristic information cannot be distinguished from another flow having the latter piece of flow characteristic information, when they enter the edge router 301. To avoid such an inconvenience, the flow characteristic table 507 is renewed to avoid overlapping a maximum rate-to-minimum rate range of one piece of flow characteristic information with that of another piece of flow characteristic information.

To use flow characteristic information including an average rate in addition to the maximum rate and minimum rate, greater network resources required for quality guarantee are preferably selected, and the flow characteristic information is advisably renewed in accordance with a greater value selected from a comparison made between the rates.

The following discusses the way of treating flow 6 having the same flow characteristic information as that of flow 5, having the source IP address 192.168.10.10 to the destination IP address 192.168.10.20, and having the maximum rate 29 Mbps and the minimum rate 21 Mbps, on the assumption that flow 6 is streamed when the edge router 301 is measuring the respective pieces of flow characteristic information of flow 1, flow 2, flow 3, flow 4, and flow 5.

In the edge router 301 before the stream of flow 6, the QoS control table 506, flow characteristic table 507, and measured flow characteristic table 508 are as illustrated in FIG. 11(a), FIG. 12(d), and FIG. 13(a), respectively.

Similarly to the start of the stream of flow 5, when flow 6 begins to stream, then at steps S201, S207, and S208, the QoS control unit 501 allows the QoS-reserving unit 504 to make a reservation in accordance with the reservation rate 29 Mbps, which is one of the reservation parameters in the flow characteristic information having the greatest maximum rate value among the several pieces of flow characteristic information at the flow characteristic table 507. As illustrated in FIG. 11(e), the reservation parameters are registered into the QoS control table 506. At step S209, the band-measuring unit 503 measures bands of flow 6, and at step S210, the flow characteristic information of flow 6 is saved into the measured flow characteristic table 508. At step S211, no change in reservation is made because the range of the maximum rates 29 Mpbs to 21 Mbps in the flow characteristic information used for the reservation includes the range of 23 Mbps to 23 Mbps in the flow characteristic information at the measured flow characteristic table 508 of FIG. 13(b).

At step S301, the band-measuring unit 503 measures the bands of flow 6, and at step S302, the flow characteristic information at the measured flow characteristic table 508 is renewed as illustrated in FIG. 13(f). At step S303, no re-reservation is newly made because the quality guarantee of flow 6 based on the reserved reservation parameters is achievable until the end of the stream of flow 6.

This is achievable because the flow characteristic information of flow 5 has been registered at the flow characteristic table 507 when flow 6 begins to stream.

Similarly to flow 4, at steps S306 and S307, the QoS control unit 501 permits the flow characteristic table 507 to remain unchanged after the end of the stream of flow 6; the QoS control unit 501 eliminates the reservation parameters of flow 4 from the QoS control table 506, as illustrated in FIG. 11(a), while eliminating the flow characteristic information of flow 4 from the measured flow characteristic table 508, as illustrated in FIG. 13(a).

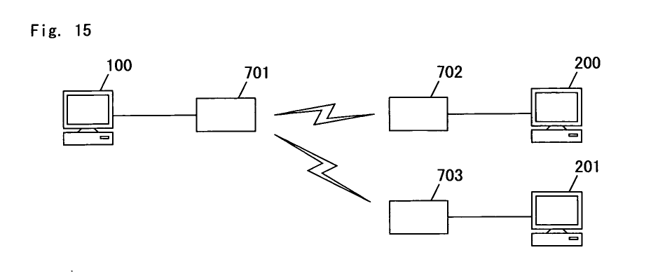

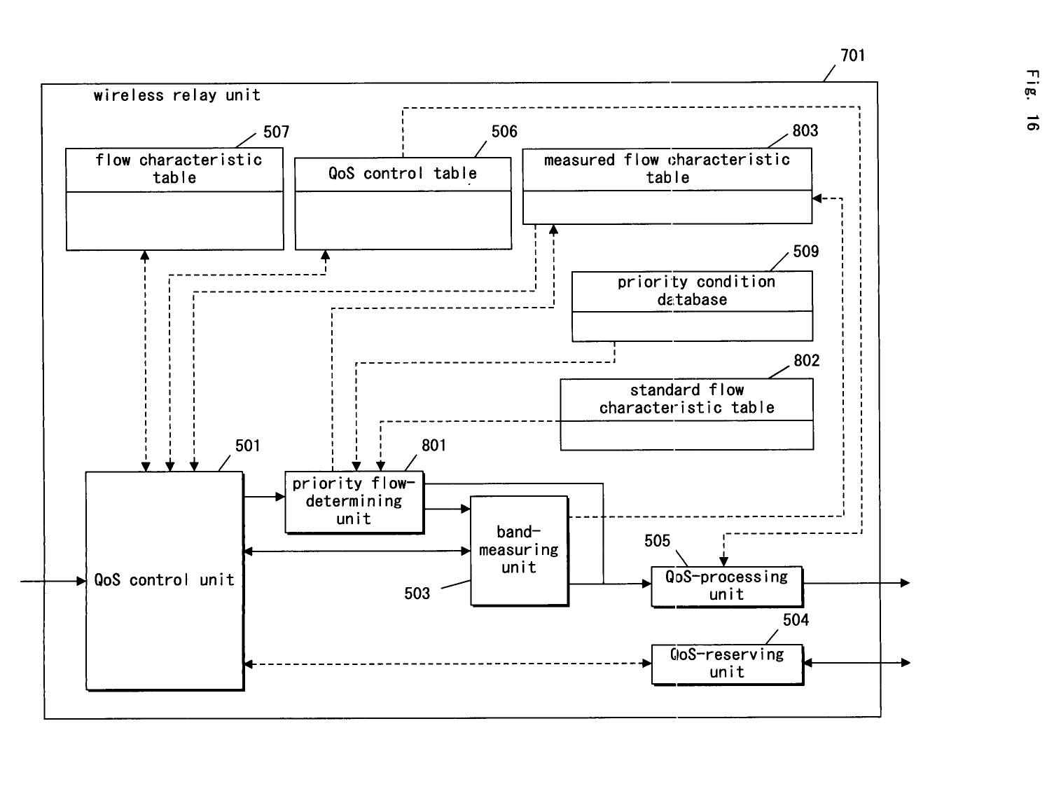

Referring to FIG. 14(a) to FIG. 14(f), variations in input rate and those in reservation rate during the respective streams of flow 1 to flow 6 are illustrated.

Although the present embodiment employs RSVP as a network resource-reserving protocol, other protocols may be used as an alternative.

### Second Embodiment

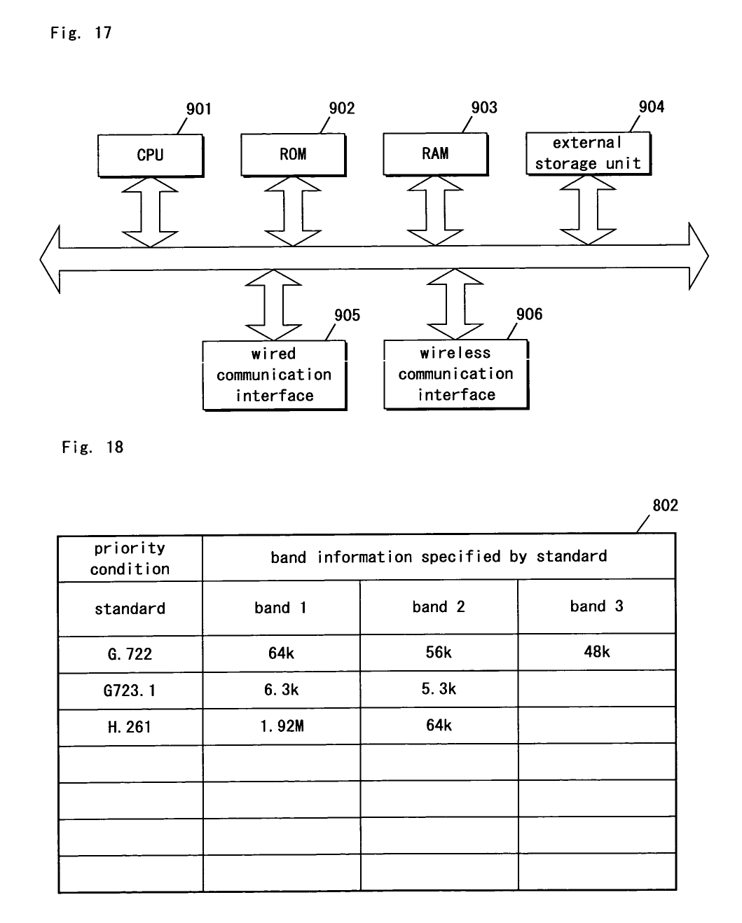

Referring to FIG. 15, a system according to a second embodiment is shown as an illustration. In FIG. 15, communication terminals 100, 200, and 201 are non-adapted for the IEEE802.11e-network resource reservation. Wireless relay units 701 to 703 are coupled together in accordance with the IEEE802.11e-wireless communication system, and are adapted for the IEEE802.11e-network resource reservation. The communication terminals 100, 200, and 201 are connected to the wireless relay units 701, 702, and 703, respectively.

In the system, assume that flow to be guaranteed in quality are streamed from the communication terminal 100 to the communication terminal 200 through the wireless relay units 701 and 702. A wireless communication zone between the wireless relay units 701 and 702 is a network zone in which network resources are reserved. According to the previous embodiment, a certain period of time elapses between the moment when the input flow unregistered at the flow characteristic table 507 is determined as priority conditions, and the moment when the network resources are reserved; the present embodiment provides a shorter period of time therebetween, and improved promptness.

Referring to FIG. 16, features of the wireless relay unit 701 according to the present embodiment are illustrated in block diagram form. The following discussion focuses on only the wireless relay unit 701 because the other wireless relay units 702 and 703 are similar in construction to the wireless relay unit 701.

As evidenced by a comparison between FIG. 16 and FIG. 2, there are differently structured units, i.e., a priority flow-determining unit 801 and a measured flow characteristic table 803. Another difference between FIG. 16 and FIG. 2 is the presence of an additional unit, i.e., a standard flow characteristic table 802.

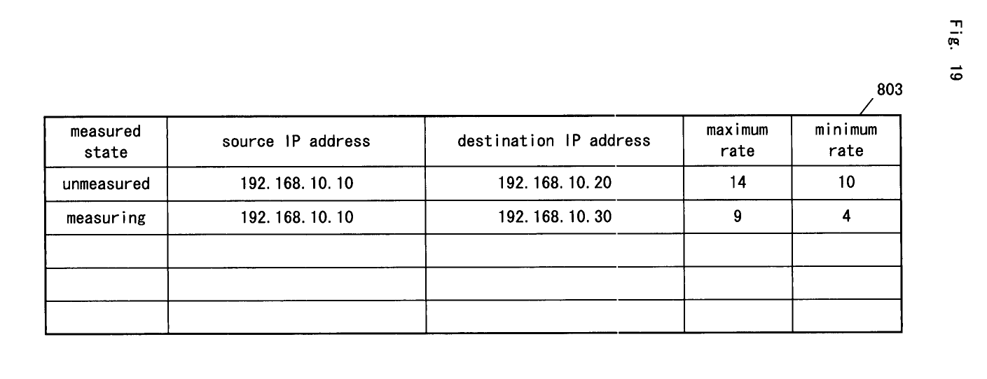

Referring to FIG. 17, a hardware structure of the wireless relay unit 701 according to the present embodiment is shown as an illustration. The wireless relay unit 701 includes a CPU 901, a ROM 902, a RAM 903, an external storage unit 904, a wired communication interface 905, and a wireless communication interface 906.

The ROM 902 stores a program for controlling the wireless relay unit 701. The program is read by the RAM 903 at the time of activation. The RAM 903 provides a domain for the measured flow characteristic table 803 and that for a QoS control table 505. The external storage unit 904 provides a domain for flow characteristic information at a flow characteristic table 507, that for a priority condition database 509, and that for the standard flow characteristic table 802.

The following discusses the priority flow-determining unit 801, standard flow characteristic table 802, and measured flow characteristic table 803 according to the present embodiment.

The standard flow characteristic table 802 is now described with reference to FIG. 18. The standard flow characteristic table 802 stores flow characteristic information determined by flow standard organizations such as ITU (International Telecommunication Union). The standard flow characteristic table 802 is used when neither the QoS control table 506 nor the flow characteristic table 507 store flow characteristic information that meets the input flow.

The following discusses the priority flow-determining unit 801 according to the present embodiment. The priority flow-determining unit 502 according to the previous embodiment is operable to determine, with reference to the priority condition database 509, whether the input flow is to be prioritized. The priority flow-determining unit 801 according to the present embodiment is operable to determine whether the input flow satisfies priority conditions registered at the standard flow characteristic table 802. When the determination in the previous step results in “YES”, the priority flow-determining unit 801 is operable to register the satisfied priority conditions into the measured flow characteristic table 803. However, when the determination in the previous step results in “NO”, then the priority flow-determining unit 801 according to the present embodiment is operable to determine whether the input flow satisfies priority conditions in the priority condition database 509.

The measured flow characteristic table 803 according to the present embodiment is now described with reference to FIG. 19. The measured flow characteristic table 803 according to the present embodiment differs from the measured flow characteristic table 508 according to the previous embodiment in terms of that the measured flow characteristic table 803 is operable to store flow characteristic information unmeasured by the band-measuring unit 503 as well as that measured thereby. Such unmeasured flow characteristic information is tentatively duplicated flow characteristic information from the standard flow characteristic table 802 when the priority flow-determining unit 801 determines that the input flow meets the standard flow characteristic table 802.

The unmeasured flow characteristic information is the flow characteristic information stored at the standard flow characteristic table 802, and is likely to differ from flow characteristic information of the input flow. As a result, when the band-measuring unit 503 measures the flow characteristic information of the input flow, then the unmeasured flow characteristic information is renewed in accordance with results from the measurement of the flow characteristic information of the input flow. The use of the flow characteristic information at the standard flow characteristic table 802 allows the network resources to be reserved before the end of the band measurement, even with the flow that streams for the first time. As a result, the flow can promptly be guaranteed in quality.

Assume that the standard flow characteristic table 802 possesses several rates specified by a standard. In this instance, when the priority flow-determining unit 801 is operable to determine the proper use of any one of the rates, then any rate to be used is viewed as unmeasured flow characteristic information. However, when the priority flow-determining unit 801 is non-operable to determine the proper use of any one of the rates, then the maximum rate used in the standard is viewed as unmeasured flow characteristic information. The QoS control unit 501 registers the unmeasured flow characteristic information into the measured flow characteristic table 803.

Although the previous and present embodiments employ the separately structured network resource-reserving apparatus and communication terminals, they may, of course, be a one-piece component as an alternative.

Pursuant to the present embodiment, when the input flow satisfies priority conditions in the priority condition database 509, then the priority flow-determining unit 801 transfers the input flow into the band-measuring unit 503, but the unmeasured flow characteristic information is unregistered into the measured flow characteristic table 803. Alternatively, the maximum network resources that can be reserved may be registered as the unmeasured flow characteristic information.

Although the present embodiment employs wireless communication as a communication pattern, the present invention is applicable to all networks, such a power line communication network, in which the network resources can be reserved.

Pursuant to the present embodiment, the wireless relay unit 701, operable to relay the flow to be guaranteed in quality, measures the flow characteristic information to reserve the network resources. Alternatively, a relaying capability-free apparatus, operable to measure the flow that streams on a transmission pathway, may be used to reserve the network resources.

The present invention advantageously eliminates the need for users to set up the network resource-reserving apparatus to make a reservation in order to guarantee the service quality of the flow from the communication terminal that is unsuited for the network resource reservation, and consequently high-quality service is readily available. In particular, the present invention advantageously reduces a quality guarantee-free period of time to an utmost extent, thereby providing improved communication quality. Furthermore, pursuant to the present invention, there is a significantly reduced likelihood of a service quality guarantee failure caused by user's erroneous set-up.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A network resource-reserving apparatus connected to a network that supports network resource reservation, said network resource-reserving apparatus comprising:
a control unit operable to identify an input flow with reference to flow-defining information;
a reserving unit operable to make a request of the network for the network resource reservation;
a measuring unit operable to measure flow characteristic information, the flow characteristic information including the flow-defining information and flow-required network resource information; and
a flow characteristic information storage unit operable to store the flow characteristic information previously measured by said measuring unit,
wherein when a certain condition is met, said reserving unit makes a request of the network for the network resource reservation in accordance with the flow characteristic information stored by said flow characteristic information storage unit.

2. A network resource-reserving apparatus as defined in claim 1, wherein when the flow characteristic information previously measured by said measuring unit is unavailable, said reserving unit makes a request of the network for the network resource reservation in accordance with a maximum available network resource.

3. A network resource-reserving apparatus as defined in claim 1, wherein when the flow characteristic information previously measured by said measuring unit is unavailable, said reserving unit makes a request of the network for the network resource reservation in accordance with a network resource having a fixed value.

4. A network resource-reserving apparatus as defined in claim 1, wherein when the flow characteristic information previously measured by said measuring unit is unavailable, said reserving unit makes a request of the network for the network resource reservation in accordance with a maximum network resource specified by a standard that is observed by the input flow.

5. A network resource-reserving apparatus as defined in claim 1, wherein said reserving unit makes a request of the network for re-reservation in accordance with a required network resource shown by the flow characteristic information of the input flow measured by said measuring unit, when the required network resource shown by the flow characteristic information of the input flow measured by said measuring unit is greater than a network resource shown by the flow characteristic information stored in said flow characteristic information storage unit.

6. A network resource-reserving apparatus as defined in claim 1, wherein said reserving unit makes a request of the network for re-reservation in accordance with a greater network resource selected from between a required network resource shown by the flow characteristic information of the input flow measured by said measuring unit and a network resource shown by the flow characteristic information stored in said flow characteristic information storage unit.

7. A network resource-reserving apparatus as defined in claim 1, wherein, with the input flow for which the network resource reservation is requested by said reserving unit, said control unit provides optimized network resources in accordance with network resources shown by the flow characteristic information of the input flow measured by said measuring unit, and wherein said reserving unit makes a request of the network for re-reservation in accordance with the optimized network resources.

8. A network resource-reserving apparatus as defined in claim 7, wherein said control unit provides the optimized network resources in such a manner as to provide minimum required network resources.

9. A network resource-reserving apparatus operable to reserve network resources in a network that supports network resource reservation, comprising:
a first unit operable to store first network resource information and second network resource information both required for each input flow, the second network resource information being older than the first network resource information;
a second unit operable to make a request of the network for the network resource reservation in accordance with the first network resource information; and
a third unit operable to make a request of the network for the network resource reservation in accordance with the second network resource information when a certain condition is met.
